(19) United States
(12) Patent Application Publication
(10) Pub. No.: US 2019/0354988 A1
(43) Pub. Date: Nov. 21, 2019

(54) Partial Fingerprint and Partial Iris Payment Device

(71) Applicant: Jiedong Zhong, Gaozhou (CN)

(72) Inventor: Jiedong Zhong, Gaozhou (CN)

(21) Appl. No.: 16/531,023

(22) Filed: Aug. 3, 2019

Related U.S. Application Data
(63) Continuation-in-part of application No. PCT/CN2017/088180, filed on Jun. 14, 2017.

(51) Int. Cl. G06Q 20/40; G06K 9/00

(52) U.S. Cl. CPC G06Q 20/40145; G06K 9/00617; G06K 9/00087

(57) ABSTRACT

A partial fingerprint and partial iris payment device, which comprises partial fingerprint and partial iris collection means, payment fingerprint and iris collection means, and a storage and matching unit; the payment fingerprint and iris collection means is used for extracting, during user payment, a fingerprint and an iris of the user that respectively correspond to the partial fingerprint and/or the partial iris; and the storage and matching unit is used for respectively matching, during the user payment, the partial fingerprint and/or the partial iris with the fingerprint and/or the iris, and sending a payment instruction when the matching is successful. The present invention realizes an extremely high identification effect and accuracy during payment. Moreover, the extraction of a partial fingerprint and partial iris will not cause a substantively negative impact and potentially negative impact on the individual with regard to any privacy and legal risks, etc.

### CROSS REFERENCE TO RELATED APPLICATIONS

The present application is a Continuation-In-Part application of PCT Application No. PCT/CN2017/088180 filed on Jun. 14, 2017, the contents of which are incorporated herein by reference in their entirety.

### TECHNICAL FIELD

The present invention relates to a payment device, and in particular to a partial fingerprint and partial iris payment device.

### BACKGROUND ART

Fingerprint and iris are inherent features of an individual after birth, and people often conduct economic activities by way of extracting fingerprint and iris, which have extremely high application value, but have great potential problems and risks. First, there may be a privacy risk, second, a legal risk, and a criminal risk of the extracted, stored and applied fingerprint or iris being exploited; and an unexpected risk of the extracted, stored and applied fingerprint or iris being uncertain within a vital activity period of an individual.

### SUMMARY OF THE INVENTION

The technical problem to be solved in the present invention is to overcome the shortcomings in the prior art, and the present invention provides a partial fingerprint and partial iris payment device. By utilizing inherent characteristics of partial fingerprint and partial iris, an individual is identified with an extremely high identification effect and accuracy during payment. Moreover, the extraction of partial fingerprint and partial iris will not cause a substantively negative impact and potentially negative impact on the individual with regard to any privacy and legal risks, etc.

The present invention solves the above technical problems by the following technical solutions:

The present invention discloses a partial fingerprint and partial iris payment device, which comprises partial fingerprint and partial iris collection means, payment fingerprint and iris collection apparatus, and a storage and matching unit, wherein the partial fingerprint and partial iris collection means is used for extracting a partial fingerprint and/or a partial iris of a user, the partial fingerprint being a fingerprint representing a partial region of a fingerprint of the user, and the partial iris being an iris representing partial independent feature points of the user; the payment fingerprint and iris collection means is used for extracting, during user payment, a fingerprint and/or an iris of the user, wherein the fingerprint and the iris respectively correspond to the partial fingerprint and the partial iris, the fingerprint is a fingerprint of the whole region of a finger corresponding to the partial fingerprint, and the iris is an iris of all independent feature points of an eye corresponding to the partial iris; and the storage and matching unit is used for storing the partial fingerprint and the partial iris from the partial fingerprint and partial iris collection means, and is further used for matching, during the user payment, the partial fingerprint and/or the partial iris with the fingerprint and/or the iris respectively, and sending a payment instruction when the matching is successful.

Preferably, the partial fingerprint and partial iris collection means comprises a partial fingerprint and partial iris collector, a first image generation unit and a user collection confirmation unit, wherein the partial fingerprint and partial iris collector is used for collecting the partial fingerprint and the partial iris; the first image generation unit is used for patterning a region corresponding to the partial fingerprint and/or independent feature points corresponding to the partial iris to form a feature image representing the user; and the user collection confirmation unit is used for performing a confirmation operation after the user accepts the feature image.

Preferably, the partial fingerprint and partial iris collection means further comprises an encryption unit for encrypting the feature image confirmed by the user.

Preferably, the partial fingerprint is a valid region fingerprint accounting for 5% to 95% of all feature points of the fingerprint of the user, and the partial iris is a valid region iris accounting for 2.8% to 95% of all the independent feature points of the iris of the user.

Preferably, the partial fingerprint is a region fingerprint with an extraction range of the partial fingerprint being from 18 degrees to 342 degrees when a fingerprint region rotates at 360 degrees around a fingerprint center point for division.

Preferably, the partial iris is an iris of 5 to 164 of the independent feature points.

Preferably, the payment fingerprint and iris collection means comprises a payment fingerprint and iris collector and a second image generation unit, wherein the payment fingerprint and iris collector is used for collecting, during the user payment, a fingerprint representing the whole region of the fingerprint of the user and/or the iris of all the independent feature points, and transmitting the fingerprint representing the whole region of the fingerprint of the user and/or the iris of all the independent feature points to the storage and matching unit; and the second image generation unit is used for patterning the fingerprint representing the whole region and/or the iris of all the independent feature points to form the feature image representing the user.

Preferably, the payment fingerprint and iris collector further comprises a payment user confirmation unit, wherein the payment user confirmation unit is used for receiving a conformation instruction sent when the matching performed by the storage and matching unit is successful, and transmitting an operation completion confirmation signal to the storage and matching unit; and the storage and matching unit sends a payment instruction after receiving the operation completion confirmation signal transmitted by the payment user confirmation unit.

The positive improvement effects of the present invention are as follows:

According to the present invention, by utilizing inherent characteristics of partial fingerprint and partial iris, an individual is identified with an extremely high identification effect and accuracy during payment. Moreover, the extraction of partial fingerprint and partial iris will not cause a substantively negative impact and potentially negative impact on the individual with regard to any privacy and legal risks, etc. The product of the present invention can also extract partial fingerprint and partial iris range features as few as possible according to actual situations to deal with a variety of potential risks, and further encrypt the extracted partial fingerprint and partial iris features, thereby completely ensuring that the extracted partial fingerprint and partial iris are of no use when images or features stored on a sever are abnormally or illegally obtained.

### BRIEF DESCRIPTION OF THE DRAWINGS

FIG. 1 is a structural schematic diagram of a preferred embodiment of the present invention.

FIG. 2 is a working flowchart of partial fingerprint and partial iris collection means of the present invention.

FIG. 3 is a working flowchart of payment fingerprint and iris collection means of the present invention.

### DETAILED DESCRIPTION OF EMBODIMENTS

The present invention is further described below by embodiments, but the present invention is not therefore limited within the scope of the embodiments.

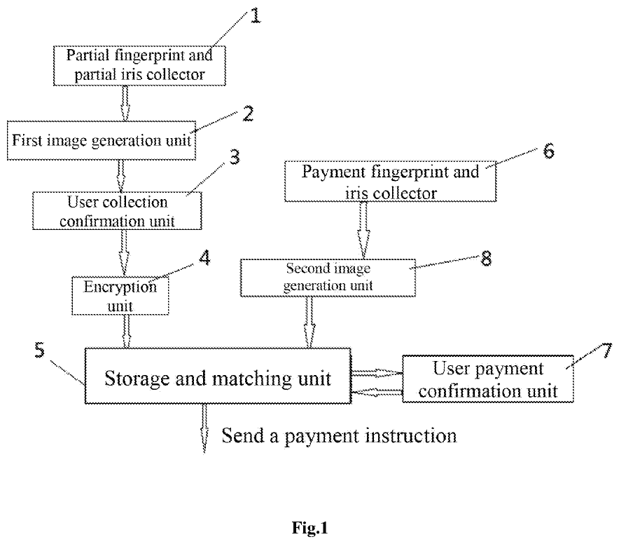

With reference to FIG. 1, the present invention discloses a partial fingerprint and partial iris payment device, which comprises partial fingerprint and partial iris collection means, payment fingerprint and iris collection means, and a storage and matching unit 5. The partial fingerprint and partial iris collection means is used for extracting a partial fingerprint and/or a partial iris of a user, the partial fingerprint being a fingerprint representing a partial region of a fingerprint of the user, and the partial iris being an iris representing partial independent feature points of the user. The payment fingerprint and iris collection means is used for extracting, during user payment, a fingerprint and/or an iris of the user, wherein the fingerprint and the iris respectively correspond to the partial fingerprint and the partial iris, the fingerprint is a fingerprint of the whole region of a finger corresponding to the partial fingerprint, and the iris is an iris of all independent feature points of an eye corresponding to the partial iris. The storage and matching unit 5 is used for storing the partial fingerprint and the partial iris from the partial fingerprint and partial iris collection means, and the storage and matching unit 5 is further used for matching, during the user payment, the partial fingerprint and/or the partial iris with the fingerprint and/or the iris respectively, and sending a payment instruction when the matching is successful. The present invention is applicable to the case where a user voluntarily provides one or both of a partial fingerprint and a partial iris.

The partial fingerprint and partial iris collection means comprises a partial fingerprint and partial iris collector 1, a first image generation unit 2 and a user collection confirmation unit 3. The partial fingerprint and partial iris collector 1 is used for a partial fingerprint and a partial iris. The first image generation unit 2 patterns a region corresponding to the partial fingerprint and independent feature points corresponding to the partial iris to form a feature image representing a user, that is, generating a corresponding image by scanning, giving a corresponding extraction range according to a data center and generating an image. The user collection confirmation unit 3 is used for performing a confirmation operation after the user accepts the feature image. If the user does not accept the feature image, the first image generation unit 2 narrows the extraction range again until the user accepts and confirms the feature image.

More preferably, the partial fingerprint and partial iris collection means further comprises an encryption unit 4, wherein the encryption unit 4 is used for encrypting the feature image confirmed by the user, and then storing the feature image on the storage and matching unit 5 to function as image data for identifying the user identity. The storage and matching unit 5 is connected to a server on which a payment account of the user is set.

When a region is randomly divided, in the present invention, the partial fingerprint is a valid region fingerprint accounting for 5% to 95% of all feature points of the fingerprint of the user, which, if illustrated in quantity, is a region fingerprint with an extraction range of the partial fingerprint being 18 degrees to 342 degrees when a fingerprint region rotates at 360 degrees around a fingerprint center point for division. The fingerprint of any one of 10 fingers of a user can be used as an extraction object, which is decided by an individual. After the user has selected a finger, any one or more regions of a fingerprint image can be randomly extracted.

In the present invention, the partial iris is a valid region iris accounting for 2.8% to 95% of all independent feature points of the iris of the user, and the partial iris is an iris of 5 to 164 independent feature points. An iris has about 266 quantified feature points, and at most 173 independent feature points can be obtained. In the present invention, 5 to 164 independent feature points can be extracted, and different extraction range parameters are used according to the similarity of independent feature points of the iris of the user. The selection of the left eye or right eye is decided by the individual himself.

The payment fingerprint and iris collection means comprises a payment fingerprint and iris collector 6 and a second image generation unit 8. The payment fingerprint and iris collector 6 is used for collecting, during user payment, a fingerprint representing the whole region of a fingerprint of a user and the iris of all independent feature points, and transmitting the fingerprint representing the whole region of the fingerprint of the user and the iris of all the independent feature points to the storage and matching unit 5. The second image generation unit 8 is used for patterning the fingerprint representing the whole region and/or the iris of all the independent feature points to form a feature image representing the user. Therefore, a fingerprint or an iris is provided voluntarily by the user in the case where payment is required, and the second image generation unit 8 generates a feature image and transmits same to the storage and matching unit 5 for matching.

Further, the payment fingerprint and iris collector 6 further comprises a payment user confirmation unit 7, wherein the payment user confirmation unit 7 is used for receiving a conformation instruction sent when the matching performed by the storage and matching unit 5 is successful (that is, when the matching degree is the highest), and transmitting an operation completion confirmation signal to the storage and matching unit, and the storage and matching unit 5 sends a payment instruction after receiving the operation completion confirmation signal transmitted by the payment user confirmation unit 7. If the user performs confirmation, the user uses a gesture or password preserved for payment for final confirmation to complete a user's voluntary payment action and complete the payment process. If the user does not perform confirmation, the user needs to repeat the above steps again to complete payment.

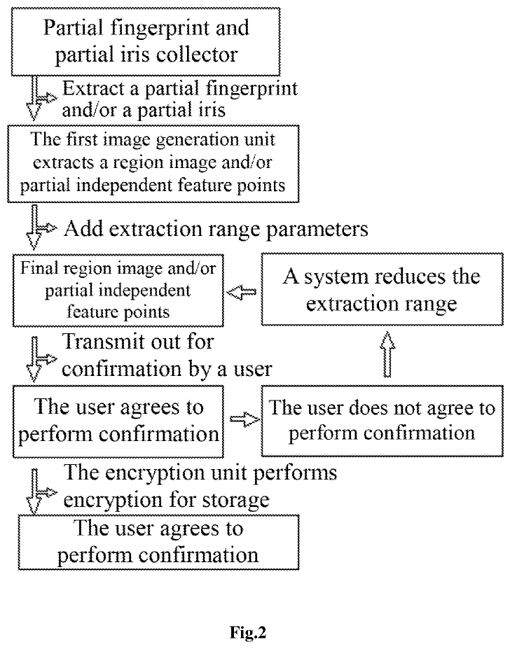

Reference is made to FIG. 2 for the working flowchart of the partial fingerprint and partial iris collection means of the present invention, in which the partial fingerprint and partial iris collector 1 extracts a partial fingerprint and/or a partial iris; the first image generation unit 2 extracts a region image and/or partial independent feature points; extraction range parameters are added to generate a final region image and/or partial independent feature points; the final region image and/or partial independent feature points are transmitted out for confirmation by a user; if the user performs confirmation, the encryption unit 4 performs encryption for storage in the storage and matching unit 5; if the user does not agree to perform confirmation, a system reduces the extraction range to generate a final region image and/or partial independent feature points again; the final region image and/or partial independent feature points are transmitted out for confirmation by the user, until the user performs confirmation; and the encryption unit 4 performs encryption for storage in the storage and matching unit 5.

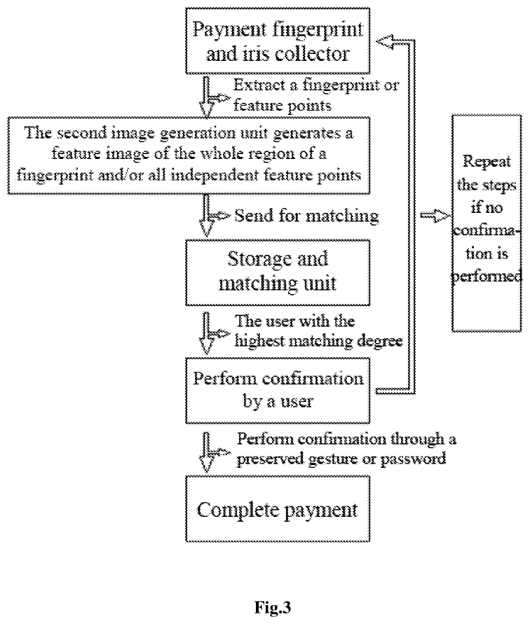

Reference is made to FIG. 3 for the working flowchart of the payment fingerprint and iris collector of the present invention, in which the payment fingerprint and iris collector 6 extracts a fingerprint or feature points of a user; the second image generation unit 8 generates a feature image of the whole region of a fingerprint and/or all feature points; the feature image is sent to the storage and matching unit 5 for matching to confirm whether the user is the one with the highest matching degree; if the user confirms agreement, a gesture or password is used to complete payment; and if the user does not perform confirmation, the payment fingerprint and iris collector 6 re-extracts a fingerprint or feature points of the user for subsequent confirmation until the user confirms agreement to pay.

Partial fingerprint and partial iris are used as biological features of a human body to identify an individual in the present invention, as fingerprint and iris are the most stable and unique biological features of human bodies, which accompany an individual until all features of life activities disappear. Depending on the inherent characteristics of fingerprint and iris, they are very reliable and suitable for payment. According to the present invention, by utilizing inherent characteristics of partial fingerprint and partial iris, an individual is identified with an extremely high identification effect and accuracy during payment. Moreover, the extraction of partial fingerprint and partial iris will not cause a substantively negative impact and potentially negative impact on the individual with regard to any privacy and legal risks, etc. The product of the present invention can also extract partial fingerprint and partial iris range features as few as possible according to actual situations to deal with a variety of potential risks, and further encrypt the extracted partial fingerprint and partial iris features, thereby completely ensuring that the extracted partial fingerprint and partial iris are of no use when images or features stored on a sever are abnormally or illegally obtained.

The present invention has been described above in detail with reference to the embodiments of the accompanying drawings, and variations of the embodiments of the present invention can be made by those of ordinary skill in the art in light of the above description. Any modification, equivalent substitution, improvement, and the like made within the spirit and principle of the present invention shall be included into the protection scope of the present invention. Therefore, some details in the embodiments should not be construed as a limitation on the present invention, and the protection scope of the present invention is subject to the scope defined by the appended claims.

1. A partial fingerprint and partial iris payment device, comprising: partial fingerprint and partial iris collection means, payment fingerprint and iris collection means, and a storage and matching unit, wherein the partial fingerprint and partial iris collection means is used for extracting a partial fingerprint and/or a partial iris of a user, the partial fingerprint being a fingerprint representing a partial region of a fingerprint of the user, and the partial iris being an iris representing partial independent feature points of the user; the payment fingerprint and iris collection means is used for extracting, during user payment, a fingerprint and/or an iris of the user, wherein the fingerprint and the iris respectively correspond to the partial fingerprint and the partial iris, the fingerprint is a fingerprint of the whole region of a finger corresponding to the partial fingerprint, and the iris is an iris of all independent feature points of an eye corresponding to the partial iris; and the storage and matching unit is used for storing the partial fingerprint and the partial iris from the partial fingerprint and partial iris collection means, and is further used for matching, during the user payment, the partial fingerprint and/or the partial iris with the fingerprint and/or the iris respectively, and sending a payment instruction when the matching is successful.

2. The partial fingerprint and partial iris payment device according to claim 1, wherein the partial fingerprint and partial iris collection means comprises a partial fingerprint and partial iris collector, a first image generation unit and a user collection confirmation unit, wherein the partial fingerprint and partial iris collector is used for collecting the partial fingerprint and the partial iris; the first image generation unit is used for patterning a region corresponding to the partial fingerprint and/or independent feature points corresponding to the partial iris to form a feature image representing the user; and the user collection confirmation unit is used for performing a confirmation operation after the user accepts the feature image.

3. The partial fingerprint and partial iris payment device according to claim 2, wherein the partial fingerprint and partial iris collection means further comprises an encryption unit for encrypting the feature image confirmed by the user.

4. The partial fingerprint and partial iris payment device according to claim 2, wherein the partial fingerprint is a valid region fingerprint accounting for 5% to 95% of all feature points of the fingerprint of the user, and the partial iris is a valid region iris accounting for 2.8% to 95% of all the independent feature points of the iris of the user.

5. The partial fingerprint and partial iris payment device according to claim 4, wherein the partial fingerprint is a region fingerprint with an extraction range of the partial fingerprint being from 18 degrees to 342 degrees when a fingerprint region rotates at 360 degrees around a fingerprint center point for division.

6. The partial fingerprint and partial iris payment device according to claim 4, wherein the partial iris is an iris of 5 to 164 of the independent feature points.

7. The partial fingerprint and partial iris payment device according to claim 1, wherein the payment fingerprint and iris collection means comprises a payment fingerprint and iris collector and a second image generation unit, wherein the payment fingerprint and iris collector is used for collecting, during the user payment, a fingerprint representing the whole region of the fingerprint of the user and/or the iris of all the independent feature points, and transmitting the fingerprint representing the whole region of the fingerprint of the user and/or the iris of all the independent feature points to the storage and matching unit; and the second image generation unit is used for patterning the fingerprint representing the whole region and/or the iris of all the independent feature points to form the feature image representing the user.

8. The partial fingerprint and partial iris payment device according to claim 7, wherein the payment fingerprint and iris collector further comprises a payment user confirmation unit, wherein the payment user confirmation unit is used for receiving a conformation instruction sent when the matching performed by the storage and matching unit is successful, and transmitting an operation completion confirmation signal to the storage and matching unit; and the storage and matching unit sends a payment instruction after receiving the operation completion confirmation signal transmitted by the payment user confirmation unit.
